(19) United States
(12) Patent Application Publication
(10) Pub. No.: US 2012/0317084 A1
(43) Pub. Date: Dec. 13, 2012

(54) METHOD AND SYSTEM FOR ACHIEVING DATA DE-DUPLICATION ON A BLOCK-LEVEL STORAGE VIRTUALIZATION DEVICE

(75) Inventor: Hui Liu, Haidian District (CN)

(73) Assignee: Beijing Z&W Technology Consulting Co., Ltd., Haidian District (CN)

(21) Appl. No.: 13/380,935

(22) PCT Filed: Aug. 1, 2011
(86) PCT No.: PCT/CN11/77890

§ 371 Date: Dec. 27, 2011

(30) Foreign Application Priority Data
Jun. 13, 2011 (CN) 201110156839.0
Aug. 1, 2011 (CN) PCT/CN2011/077890

(51) Int. Cl. G06F 17/30

(52) U.S. Cl. 707/692; 707/E17.005

(57) ABSTRACT

A method and system for achieving data de-duplication on a block-level storage virtualization device belonging to the field of data storage technologies, is disclosed. The method comprises: deleting the duplicate data in the actual physical data corresponding to the specified virtual LBA address space to obtain the data extents after physical data is de-duplicated; establishing the correspondence between the virtual LBA address space and the data extents after the physical data is de-duplicated; according to the correspondence and metadata information of the data extents, obtaining the storage position information of the actual physical data corresponding to the virtual LBA address space pointed by external data read and write requests to complete the I/O redirection. This invention also provides a system for achieving data de-duplication on a block-level storage virtualization device. This invention can delete duplicate data across hosts and storage devices, to achieve a wider scope of data de-duplication.

### FIELD OF TECHNOLOGY

This invention relates to the field of data storage technology, and in particular, relates to a method and system for achieving data de-duplication on the block-level storage virtualization device.

### BACKGROUND TECHNOLOGY

In the context that the amount of global data is doubled in 18 to 24 months on average and a substantial increase in enterprise data retention period is required by law by force, the data de-duplication technology is of very important significance. The technology is one of the important means for enterprises to reduce storage cost, and thereby to reduce IT spending and remain competitive. The data de-duplication application technology on the traditional block-level storage devices has been very mature, and has been commercialized in a large-scale manner.

However, with the introduction of the storage virtualization technology, the overall architecture of storage systems has changed a lot, and this change is mainly manifested in: a virtualization layer is added for the storage virtualization device system architecture in the traditional storage architecture, and thus a three-layer architecture of host layer, virtualization layer and physical storage device layer (such as JBOD and disk array) is formed. The host layer and physical storage device layer are fully consistent with the traditional storage system, and the virtualization layer is a software layer (or a software function module is embedded within hardware). The built-in software of the virtualization layer virtualizes the homogeneous or heterogeneous physical storage devices in the physical storage device layer at the bottom into a unified storage resource pool, and by building the correspondence between the physical LUN (Logical Unit Number) and virtual LUN the virtual LUN is available to mount for the front-end host, thus eliminating the differences between heterogeneous storage devices, so that all storage resources can be unified and managed via a unified interface, simplifying the storage management and service costs dramatically; coupled with the thin provisioning, and non-disruptive data migration and other functions provided by it, the service efficiency of storage devices has been greatly improved.

With the in-depth use of the storage virtualization technology, some drawbacks of the traditional data de-duplication solutions are also exposed specifically reflected in the following areas:

1. Data de-duplication on the host layer requires users to deploy data de-duplication software on each host connected with a virtual storage device, and then to delete the duplicate data within the specified host scope. However, this approach has the following limitations: \textcircled{1} the scope of data duplication is only limited to each host installed with data de-duplication software and the data managed by it, and the duplicate data across the host can not be deleted; \textcircled{2} the data de-duplication software needs to be installed on each host, and a lot of resources need to be consumed for the calculation and comparison of the fingerprints of duplicate data executed by the software, so it will affect the performance of the host.

2. Data de-duplication on the physical storage device layer, requires the storage virtualization layer as a medium, and all or part of its connected storage devices need to have their own data de-duplication. However, this approach has the following limitations: \textcircled{1} the scope of data de-duplication is often limited to a specific storage device but the data de-duplication within a full scope cannot be achieved, thus affecting the proportion and effect of the overall data deletion; \textcircled{2} data migration between heterogeneous storage devices requires the use of another independent host, that is, the data is restored before migration, thus affecting the performance of data migration; \textcircled{3} the metadata management mechanisms and policies used by different storage devices with data de-duplication are different, so it is difficult to achieve unified management of the integrated heterogeneous storage resources.

### INVENTION CONTENT

In order to overcome the limitations of traditional methods in achieving data de-duplication on storage virtualization devices, this invention proposes a method for achieving data de-duplication in the virtualization layer (non-host layer and physical storage device layer) of block-level storage virtualization device, and the method comprises:

deleting the duplicate data in the actual physical data corresponding to the specified virtual LBA address space to obtain the data extents after the physical data is de-duplicated;

establishing the correspondence between the virtual LBA address space and the data extents after the physical data is de-duplicated;

and according to the correspondence and metadata information of the data extents, obtaining the storage position information of the actual physical data corresponding to the virtual LBA address space pointed by external data read and write requests to complete the I/O redirection.

Before the step of deleting the duplicate data in the actual physical data corresponding to the specified virtual LBA address space it also comprises: setting the data de-duplication policy and the smallest data operation unit of data de-duplication.

The step of deleting the duplicate data in the actual physical data corresponding to the specified virtual LBA address space specifically comprises:

according to the smallest operation unit of data de-duplication, extracting data of a specified length for data de-duplication from the actual physical data corresponding to the virtual LBA address space;

according to the data de-duplication policy, dividing the data of specified length in accordance with the smallest operation unit of data de-duplication into the data extents of specified sizes;

and calculating the data fingerprints of the data extents of specified sizes and comparing with the data fingerprints stored in the data fingerprint database, and deleting the duplicate data in the actual physical data according to the same comparison results of data fingerprints.

The step of obtaining the data extents after the physical data is de-duplicated also comprises: updating the metadata of the de-duplicated data extents.

The smallest data operation unit of data de-duplication is an integer multiple of block, bit or byte.

The structure of the block-level storage virtualization device is in-band or out-of-band architecture.

This invention provides a system for achieving data de-duplication on block-level storage virtualization device, and the system comprises:

a virtual LUN device for providing the front-end host to mount and use;

a data de-duplication module for deleting the duplicate data in the actual physical data corresponding to the specified virtual LBA address space to obtain the de-duplicated data extents;

a global metadata management module for creating the correspondence between the virtual LBA address space and the de-duplicated data extents, managing and updating the metadata in the global metadata pool device, and according to the received virtual LBA address space, the correspondence and the metadata information of the de-duplicated data extents, obtaining the storage position information of the actual physical data corresponding to the virtual LBA address space and sending the storage position information;

a global metadata pool device for storing the information of the correspondence established by the global metadata management module and the metadata information of the de-duplicated data extents obtained by the data de-duplication module;

a storage virtualization module for sending the virtual LBA address space requested by the external data read and write I/O to the global metadata management module, and receiving the storage position information of the actual physical data corresponding to the virtual LBA address space sent by the global metadata management module to complete the I/O redirection;

a physical LUN device for storing the actual physical data.

The data de-duplication module includes:

a setting unit for setting the data de-duplication policy and the smallest operation unit of data de-duplication;

an obtention unit for obtaining the storage position information of the actual physical data corresponding to the specified virtual LBA address space;

an extraction unit for extracting the data of specified length for data de-duplication from the physical LUN device based on the storage position information of the actual physical data obtained by the obtention unit in accordance with the smallest data operation unit of data de-duplication set by the setting unit;

a segmentation unit for segmenting the data of specified length extracted by the extraction unit according to the data de-duplication policy set by the setting unit into the data extents of specified size in accordance with the smallest data operation unit of data de-duplication set by the setting unit;

a data fingerprint database unit for storing data fingerprints;

a data de-duplication unit for calculating the data fingerprints of the data extents of specified sizes segmented by the segmentation unit, comparing with the data fingerprints stored in the data fingerprint database unit, and sending the comparison results;

a metadata management and updating unit for receiving the comparison results, and while the comparison results are the same, to send the metadata update content and request to the global metadata management module.

The smallest data operation unit of data de-duplication is an integer multiple of block, bit or byte.

This invention also provides a system for achieving data de-duplication on the block-level storage virtualization device, and the system comprises:

a virtual LUN device for providing the front-end host to mount and use;

a storage virtualization metadata pool device for storing the metadata information corresponding to the virtual LBA address space;

a data de-duplication metadata pool device for storing the metadata information of the data extents after data de-duplicated by the data de-duplication module;

a data de-duplication module for deleting the duplicate data in the actual physical data corresponding to the specified virtual LBA address space, to obtain the de-duplicated data extents, and updating the metadata information in the data de-duplication metadata pool device;

a global metadata management module for creating the correspondence between the virtual LBA address space and the de-duplicated data extents, and synchronizing and coordinating the updating and interaction of the metadata between the storage virtualization module and data de-duplication module;

a storage virtualization module for obtaining the storage position information of the actual physical data corresponding to the virtual LBA address space pointed by the external data read and write requests according to the correspondence established by the global metadata management module and the metadata information of the data extents after data de-duplicated by the data de-duplication module to complete the I/O redirection, and updating the metadata information in the storage virtualization metadata pool device;

a physical LUN device for storing the actual physical data.

The data de-duplication module includes:

a setting unit for setting the data de-duplication policy and the smallest data operation unit of data de-duplication;

an obtention unit for obtaining the storage position information of the actual physical data corresponding to the specified virtual LBA address space;

an extraction unit for extracting the data of specified length for data de-duplication from the physical LUN device based on the storage position information of the actual physical data obtained by the obtention unit, in accordance with the smallest data operation unit of data de-duplication set by the setting unit;

a segmentation unit for segmenting the data of specified length extracted by the extraction unit according to the data de-duplication policy set by the setting unit into the data extents of specified sizes in accordance with the smallest data operation unit of data de-duplication set by the setting unit;

a data fingerprint database unit for storing data fingerprints;

data de-duplication unit, used for calculating the data fingerprints of the data extents of specified sizes segmented by the segmentation unit, comparing with the data fingerprints stored in the data fingerprint database unit, and sending the comparison results;

a metadata management and updating unit for receiving the comparison results, and while the comparison results are the same, updating the metadata of the de-duplicated data extents through the co-ordination of the global metadata management module, and sending the updated metadata to the de-duplication metadata pool device.

The smallest data operation unit of data de-duplication is an integer multiple of block bit or byte.

Compared with the prior arts, the beneficial effects of these technical solutions above to this invention are as follows:

1. The technical solutions provided by this invention can be used to delete duplicate data across hosts and storage devices, to achieve a wider scope of data de-duplication;

2. The technical solutions provided by this invention do not take up the host system resources, thus ensuring the business applications running on the host can run smoothly;

3. The technical solutions provided by this invention can centrally manage and protect the metadata of data de-duplication and simplify the entire system design and implementation.

### DESCRIPTION OF FIGURES

FIG. 1 shows the structure diagram of a system for achieving data de-duplication on the block-level storage virtualization device provided to this invention embodiment 1;

FIG. 2 shows the flow chart of a method for achieving data de-duplication on the block-level storage virtualization device provided to this invention embodiment 1;

FIG. 3 shows the structure diagram of a data de-duplication module illustrated in this invention embodiment 1;

FIG. 4 shows the structure diagram of the systems before a data de-duplication module deployed illustrated in this invention embodiment 1;

FIG. 5 shows the structure diagram of the system after a data de-duplication module is deployed but with no data de-duplicated illustrated in this invention embodiment 1;

FIG. 6 shows the structure diagram of the system after a data de-duplication module is deployed with part of the data de-duplicated illustrated in this invention embodiment 1;

FIG. 7 shows the system structure diagram of inline data read and write operations after data de-duplicated in this invention embodiment 1;

FIG. 8 shows the structure diagram of the system that merges the global metadata pool device and virtual LUN device for the centralized management of metadata in this invention embodiment 1;

FIG. 9 shows the diagram of the correspondence between the virtual LBA address space and the de-duplicated data extents in this invention embodiment 1;

FIG. 10 shows the structure diagram of the system for achieving data de-duplication on the block-level storage virtualization device provided to this invention embodiment 2;

FIG. 11 shows the structure diagram of the system for centralized metadata management provided to this invention embodiment 1.

### EMBODIMENTS

To better understand this invention, this invention is detailed in the following in combination with the drawings and specific embodiments.

Currently, deploying and achieving data de-duplication within the storage virtualization layer focus on the scope of file system-level storage virtualization device, such as the technical solutions documented in the patents WO2010/033961, PCT/US2009/057772, US 2009/0204649 and US2009/0204650; but achieving data de-duplication in the virtualization layer of block-level storage virtualization device was not recorded and no related products were implemented. On the other hand, it is not easy to achieve data de-duplication in the virtualization layer of block-level storage virtualization device, and the reasons are below:

1. A number of logically independent conversion and directing paths are available for access to a piece of actual data, that is, a piece of actual data is corresponding to multiple pieces of metadata for different data management and operating function services (such as serving the storage virtualization and data de-duplication respectively), and if the management and updating of these metadata are not synchronized and coordinated, it may result in data access confusion, and even data loss.

Unlike a conventional deployment of data de-duplication in the host layer, to realize data de-duplication in the virtualization layer of storage virtualization device, there will inevitably be a number of logically independent conversion and redirection paths to access to a same piece of physical data. First, the conversion and directing path for from the “virtual” data shown on the host layer by the virtual LBA (Logical Block Address) address of the virtual LUN to the actual data on the physical storage device; second, the conversion and pointing path for from the de-duplicated data extent (that is the “virtual” data corresponding to data de-duplication) to the actual physical storage position of its corresponding data extent reference. The conversion and directing information of these data access paths above is in this invention, known as the virtual LBA address and data extent metadata.

It can be imagined that if these “virtual” data in accordance with their respective mechanisms operate the same actual data without a synchronized updating of the corresponding metadata information, it may lead to data access confusion. For example, a piece of real physical data in the storage device layer is mapped to part of the virtual LBA address extents provided by a virtual LUN (that is, this physical data contained in the actual data mapped by the virtual LBA address), after the physical data is de-duplicated, the data on the original storage position (the actual LBA address space) may have been incomplete (some or all of the data may have been incorporated into the corresponding data extent reference), and then, if the I/O request that arrives at the virtual LBA address on the virtual LUN is redirected to the original LBA address space of the actual physical data, it will lead to incomplete or invalid data.

2. The smallest data management and operation unit are inconsistent.

The smallest data unit managed by the block-level storage virtualization device is usually the smallest data unit managed by storage media, and the smallest data unit is called a block. For example, the size of a disk is typically 512 bytes; tapes and other storage media are similar to it. Byte is usually the smallest operation unit in the traditional data de-duplication technology, to segment raw data into extents and further compare and de-duplicate them (in theory, bit can also be the smallest unit for data segmentation and de-duplication comparison).

As the smallest data operation units are inconsistent, the data de-duplication technology can not be directly used in the virtualization layer of block-level storage virtualization device. Specifically, the unit to read and write data on the block-level storage virtualization device is block, and for example, the length of a block in disk is 512 bytes; in the traditional data de-duplication technology, the smallest unit of the data to be de-duplicated is usually a byte. If the data de-duplication technology is directly used on the block-level storage virtualization device, it may lead to that the original data before data de-duplication, which is stored in a block, may be stored in at least two blocks respectively after data de-duplication (for instance the first half of the data in a block is placed in a data extent reference, and the latter part of the data is placed in another data extent reference). Although this splitting can meet the design goal of data de-duplication—the best effect of data de-duplication, it will lead to a directing path chaos in the storage virtualization layer from the “virtual” data to the actual data, and the data on the host layer will be lost, therefore the traditional method for data de-duplication can not be directly applied to the virtualization layer of the block-level storage virtualization device.

Given the above, this invention provides a method for achieving data de-duplication in the virtualization layer of block-level storage virtualization device, by obtaining the correspondence between the virtual LBA address space and the de-duplicated data extents (mapped to this virtual LBA address space), further the storage position information of the actual data corresponding to this virtual LBA address space is obtained according to the correspondence information and the metadata information of the corresponding data extents to complete the I/O redirection. In the specific implementation of this invention, the smallest data operation unit of data de-duplication needs to be set.

It should be noted that, in practical applications, with the introduction of other functions in the block-level storage virtualization device, the mapping relationship between the virtual LBA address and the storage position of its corresponding actual physical data may be affected to some extent; in other words, the two may not have the direct mapping relationship in the typical storage virtualization device, but the indirect mapping relationship that needs to go through several transformations. For example, some block-level storage virtualization devices are provided with a system design mutually mapped among multiple virtual LUNs such as a virtual layer RAID, or multi-level virtualization (to increase the capacity of virtual address space). However, no matter what kind of system design, there always exists the directing information from the virtual LBA address of data specified on a specified virtual LUN to the storage position of its corresponding actual physical data. On the other hand, the method and technical solutions in this invention mainly depend on the directing information on the virtual LBA address of data provided by block-level storage virtualization devices to the actual storage position of the data, not directly related to how to get the directing information on the storage virtualization device, so the different designs of virtual storage devices do not affect the application of the technical solutions described in this invention, and do not affect the protection scope of this invention. In view of this, the following description of this invention embodiments are only based on the instance of a typical storage virtualization system design, that is, the virtual LBA address of data is directly mapped to the storage position of its corresponding actual physical data.

In addition, in the implementation process of the method described in this invention, according to the needs of system design, the smallest data operation unit of data de-duplication can be set to the level of an integer multiple of block, byte or bit. However, though setting to the level of an integer multiple of byte and bit can avoid too much space wasted, it greatly increases the data volume of metadata, and the difficulty in metadata management. Since which level the smallest data operation unit of data de-duplication is unified to, is only related to how to implement data de-duplication itself (that is, how to segment the data of specified length and manage the metadata), without affecting the applicable scope of this invention - the realization of data de-duplication in the virtualization layer of block-level storage virtualization device, in order to simplify the following description of embodiments of this invention, the embodiment of this invention only takes the smallest data operation unit of data de-duplication setting to the block level (namely, double level of block) as the example.

Finally, the core of the method proposed in this invention is to obtain the information of the correspondence between the virtual LBA data address space and the data extents after the actual physical data corresponding to the virtual LBA address space is de-duplicated, and the metadata information of the de-duplicated data extents, but in the traditional realization method of storage virtualization and data de-duplication, the above information is usually stored in the storage virtualization metadata and data de-duplication metadata, and the management and updating are completed by their respective function module and there is no synchronization mechanism; for instance, the storage virtualization module is responsible for managing and updating the information of the virtual LBA address stored in the metadata of storage virtualization, and the data de-duplication module is responsible for managing and updating the information of data extents stored in the data de-duplication metadata information. To avoid a conflict of metadata management above, at least two systems can be used to achieve the design purpose of this invention. The first system, that is, the system described in Embodiment 1, for a centralized management and updating of the global metadata information is used to achieve the storage virtualization and data de-duplication and other functions; the second system, namely the system set forth in Embodiment 2, serves for the metadata information with different functions which is managed and updated by respective functional modules after being coordinated and synchronized at the whole system level. The implementation details of such two systems are described in the following.

### Embodiment 1: Metadata Centralized Management System

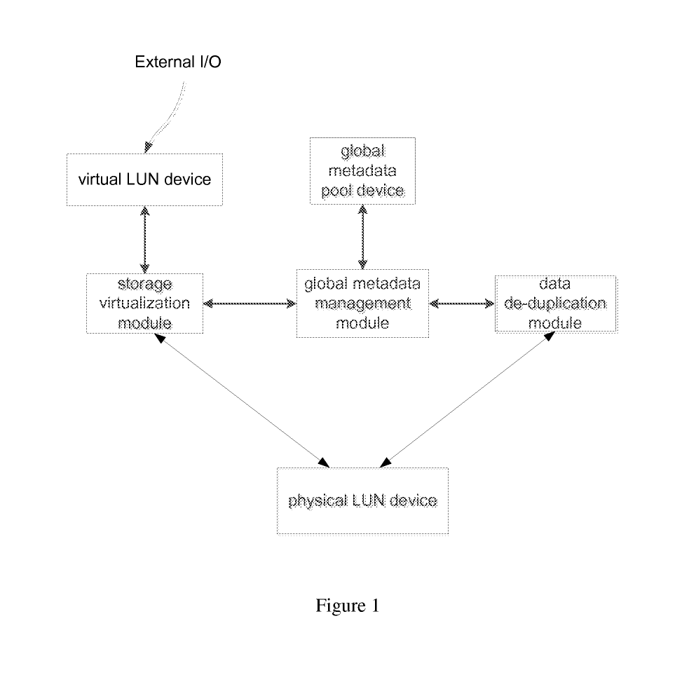

As shown in FIG. 1, the embodiment of this invention provides a centralized metadata management system for achieving data de-duplication on block-level storage virtualization device, and the system comprises:

Virtual LUN device, a virtual storage device used by the storage virtualization module to provide the front-end host to mount and use;

Data de-duplication module, used for deleting the duplicate data in the actual physical data corresponding to the specified virtual LBA address space, and obtaining the de-duplicated data extents;

Storage virtualization module, used for sending the virtual LBA address space of external data read and write I/O requests to the global metadata management module, and receiving the information of storage position of the actual physical data corresponding to the virtual LBA address space sent by the global metadata management module, to complete the I/O redirection;

Global metadata pool device, as a device corresponding to the virtual LUN, used for storing the correspondence information established by the global metadata management module and the metadata information of the de-duplicated data extents obtained by the data de-duplication module; if the post-processing data de-duplication policy (such as this embodiment of the invention) is adopted, the global metadata pool device will also store the information on the correspondence between the virtual LBA address space and the storage positions of its corresponding actual physical data pending for de-duplication; in the specific implementation, the global metadata pool device can be saved and maintained as a file or a table in database or in other forms;

Global metadata management module, used for creating the correspondence between the virtual LBA address space and the de-duplicated data extents, creating and initializing the global metadata pool device, managing and updating the metadata in the global metadata pool device, and according to the received virtual LBA address space, correspondence and the metadata information of the de-duplicated data extents, obtaining the storage position information of the actual physical data corresponding to the virtual LBA address space and sending the storage position information; If the post-processing data de-duplication policy (such as the embodiment of this invention) is used, as the actual physical data corresponding to the virtual LBA address space requested by the external I/O may not have been de-duplicated, the global metadata management module will directly return the storage position information of the actual physical data corresponding to the virtual LBA address space stored in the global metadata pool device;

Physical LUN device, as a storage device used for storing the actual physical data, usually is a storage logical unit divided out of a large storage media (such as disk array) in the layer of physical storage device, and is identified using the logical unit number (namely, LUN).

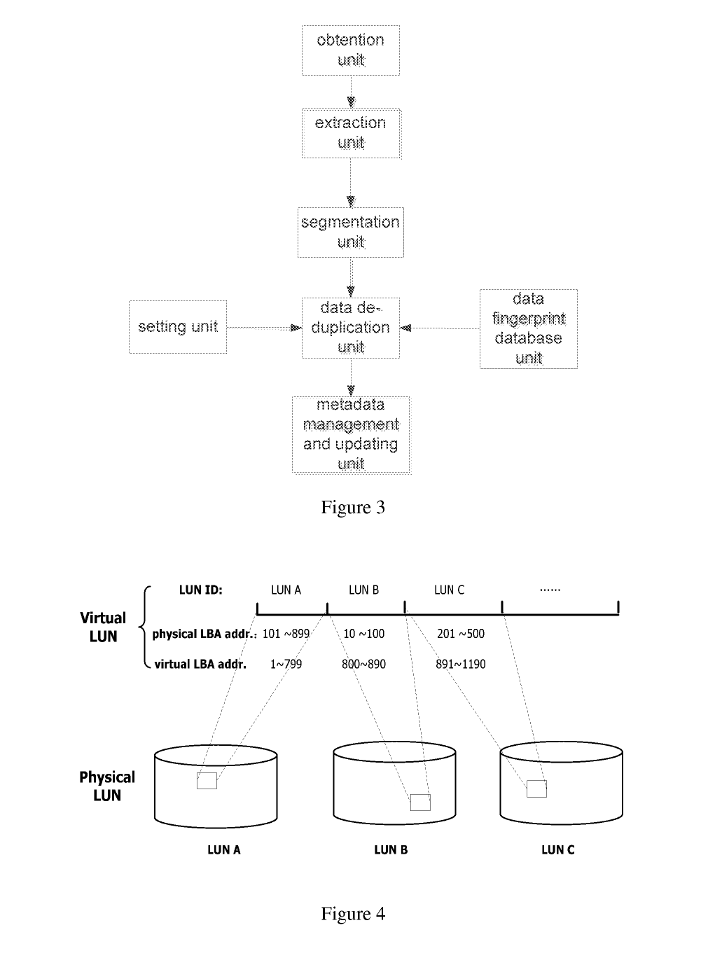

Further, the data de-duplication module includes, as shown in FIG. 3:

Setting unit, used for setting the data de-duplication policy and the smallest data operation unit of data de-duplication; the smallest data operation unit of data de-duplication can be set to an integer multiple of block, bit or byte.

Obtention unit, used for obtaining the storage position information of the actual physical data corresponding to the specified virtual LBA address space;

Extraction unit, used for extracting the data of specified length for data de-duplication according to the storage position information of the actual physical data obtained from the obtention unit, from the physical LUN device in accordance with the smallest data operation unit for data de-duplication set by the setting unit;

Segmentation unit, used for segmenting the data of specified length extracted by the extraction unit according to the data de-duplication policy set by the setting unit into the data extents of specified sizes in accordance with the smallest data operation unit of data de-duplication set by the setting unit;

Data fingerprint database unit, used for storing data fingerprints; in the data de-duplication process, through comparing the new generated fingerprints of data and fingerprint data in the fingerprint database, data de-duplication is achieved;

Data de-duplication unit, used for calculating the data fingerprints of the data extents of specified size segmented by the segmentation unit, comparing with the data fingerprints stored in the data fingerprint database and sending the comparison results;

Metadata management and updating unit, used to receive the comparison results, and while the comparison results are the same fingerprint data, sending the metadata update content and request to the global metadata management module; the global metadata management module in combination with the data read and write information in the process of data de-duplication, updates the metadata of each de-duplicated data extent.

In practical applications, the functions of the global metadata management module include: 1) being responsible for when data are read and written, coordinating the conflict between data read and write process and data de-duplication process (for instance the actual data pointed by a virtual LBA address is simultaneously requested by the data read and write process and data de-duplication process); 2) interacting with the data de-duplication module, being responsible for updating the metadata information of the de-duplicated data extent in the global metadata pool device to ensure the effectiveness and consistency of metadata information corresponding to each virtual LBA address.

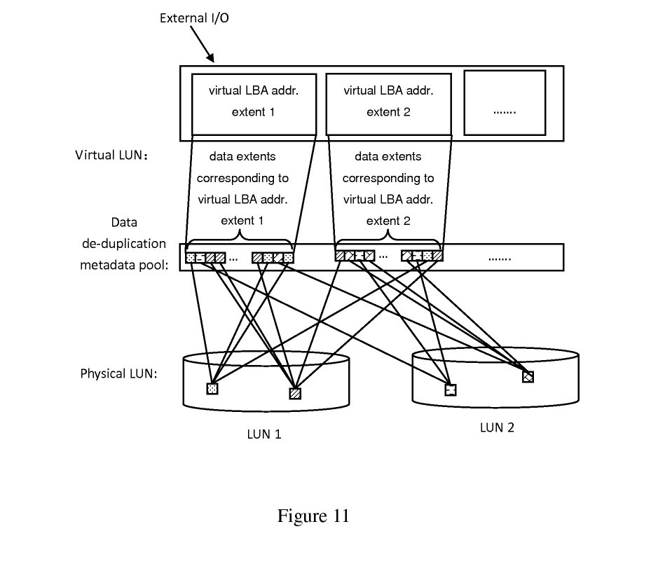

In this system, the metadata, corresponding to all the functions of the system, storage and management are centralized in the global metadata pool device and global metadata management module and according to a different position of the global metadata pool device throughout the system, the system can have multiple topology designs, typical as shown in FIG. 11 and FIG. 8; in FIG. 11, there is a metadata storage device (namely, global metadata pool device),separate from other system modules, which is dedicated to the saving and maintenance of metadata, and serves various functions of the system; in FIG. 8, the global metadata pool device is combined with the virtual LUN device. But no matter what kind of topology, its implementation method is similar. The topology as shown in FIG. 11 below is illustrated, and the system implementation details are described. In this topology, the global metadata pool device management and maintenance is centralized in the global metadata management module, keeping all the metadata throughout the system to serve the system's various functions. To simplify the description of the feasibility of this invention, the embodiment of this invention only illustrates the implementation of the storage virtualization and data de-duplication as an example, while other functions such as RAID are so such will not be detailed herein because their implementation methods are similar; in other topologies, there will also be modules and mechanisms with the functions similar to the global metadata management module, and they are used for maintenance and management of metadata but are not discussed here because their implementation methods are similar.

In practice, the virtualization of block-level storage virtualization devices is achieved by a variety of methods, typically including in-band architecture; the main commercial products are IBM SAN Volume Controller (SVC), IBM DS8000 series, Hitachi VSP series, EMC VPLEX, DataCore SAN symphony-V, and out-of-band architecture, and the main commercial products are EMC Invista and so on. But no matter what kind of implementation method, the core idea is to create a virtual LUN for the front-end host to mount and use, and the virtual LBA address space on the virtual LUN is mapped and converted to the physical positions where the corresponding real data are stored, to achieve the redirection of data read and write I/O on the virtual LUN. Since the method in this invention is implemented mainly depending on the virtual LUN and metadata in the virtualization layer, but is not related to differences in the implementation methods above (such as whether the data path and control path are separated), so in terms of this invention, a variety of methods to achieve the virtualization of block-level storage virtualization devices will not affect the applicable scope of this invention. To simplify the description of the feasibility of this invention, the embodiment of this invention only illustrates the implementation of virtualization of in-band block-level storage virtualization device as an example.

On the other hand, in the implementation, there are a variety of ways to implement the data de-duplication technology, typically including fixed-length dedup, variable-length dedup and hybrid-length dedup. But no matter what kind of implementation way, the core idea is to divide the data of specified length into the data extents with the size meeting the requirements according to the predetermined algorithm, to compare and delete the duplicate data by calculating the fingerprints of such data extents, and to keep one copy of data extent reference. Through the metadata of each data extent, to complete the redirection of all the data read and write I/Os that reach the specified data extent. Because different implementation ways of the data de-duplication technology only affect the relevant data de-duplication performance and results, etc., without affecting the feasibility of this invention, thus they will not affect the applicability of this invention to the data de-duplication solutions. To simplify the description of feasibility of this invention, the embodiment of this invention only illustrates the variable-length data de-duplication technology as the example, and the fixed-length data de-duplication can be seen as a special case to achieve the variable-length data de-duplication.

In addition, according to the timing of data de-duplication, the data de-duplication solutions can also be classified into in-line dedup and post-processing dedup. Similarly, these two solutions will only affect the overall system performance and data de-duplication effects, etc., but will not affect the feasibility of this invention, so they will not affect applicability of this invention to the above data de-duplication solutions. To simplify the description of feasibility of this invention, the embodiment of this invention illustrates the post-processing solution as the example.

Meanwhile, the technical innovation point of this invention is at how to apply data de-duplication solutions in the virtualization layer of block-level storage virtualization devices, instead of discussing how to de-duplicate data; and the data de-duplication technology is mature and widely used in practice. Therefore, the implementation details related to data de-duplication in the embodiment of this invention such as data segmentation, and calculation and comparison of data fingerprints will be omitted.

In short, the embodiment of this invention is discussed on the basis of implementing variable-length and post-processing data de-duplication on in-band block-level storage virtualization devices.

To facilitate to describe the implementation steps, some technical terms of the embodiment of this invention are explained below:

1. Block—the minimum data unit of storage media management; a block is a sequence of consecutive bytes or bits, usually with a fixed length. The size of a disk, for example, is usually 512 bytes, and the size of tape and other storage media is similar.

2. Data extent—used to describe the concept of data de-duplication, means that the data de-duplication module before deleting the duplicate data divides the data of specified length into multiple data extents that meet the size requirements according to the predetermined algorithm (the data extent dividing methods for different data de-duplication solutions are also different); the duplicate data are deleted by calculating the fingerprints of these data extents and comparing their similarities and differences. After the duplicate data are deleted, the data extent is a logical concept, and through its corresponding data extent metadata information, it points to the actual physical data stored in the corresponding data extent reference.

3. Data extent reference—used to describe the concept of data de-duplication, refers to the only copy of physical data corresponding to multiple duplicate data extents after data de-duplication, saved on the specified storage media. And after establishing the reference relationship of these data extents to the only physical data copy, herein, the only physical data copy referenced by multiple data extents is called the data extent reference corresponding to these data extents.

4. Data extent metadata—used to describe the concept of data de-duplication, is defined as the reference information (also known as directing information or pointer information) from saved data extents to its corresponding data extent reference after data de-duplication; the information contains the actual position information (such as the position of LUN physical device and the corresponding LBA address on this LUN) where the data extent reference is stored in. After data de-duplication, all the I/Os that reach a data extent will be redirected to its corresponding data extent reference based on the metadata corresponding to the data extent.

5. Virtual LBA address metadata—serving for storage virtualization (device) data access I/O redirection, the information is used to redirect I/O that reaches the specified virtual LBA address to the actual data storage position. The metadata information based on the needs of system design can contain different information, for instance in case of the realization of software RAID or multi-level virtualization on the virtual layer, the metadata will also include the information necessary for redirecting the virtual LBA address to the actual data storage position after adding these functions. In terms of this embodiment, the metadata will contain the following information: whether the actual data corresponding to the specified virtual LBA address has been de-duplicated, and if so, its corresponding data extent and the offset from the head of the data extent; If not so, the directing information of the actual data storage position corresponding to the virtual LBA address.

6. Virtual LUN metadata—primarily refers to the set of the virtual LBA address metadata contained in the virtual LUN. In reality, the metadata can be saved and maintained as a file or a table in database or in other forms.

7. Storage virtualization metadata—primarily includes at least one LUN metadata and the information that provides support to other functions (such as RAID) of the virtual LUN.

8. Data de-duplication metadata—primarily includes the data extent metadata and the information necessary to support metadata maintenance function (such as metadata storage space planning and deployment, etc.).

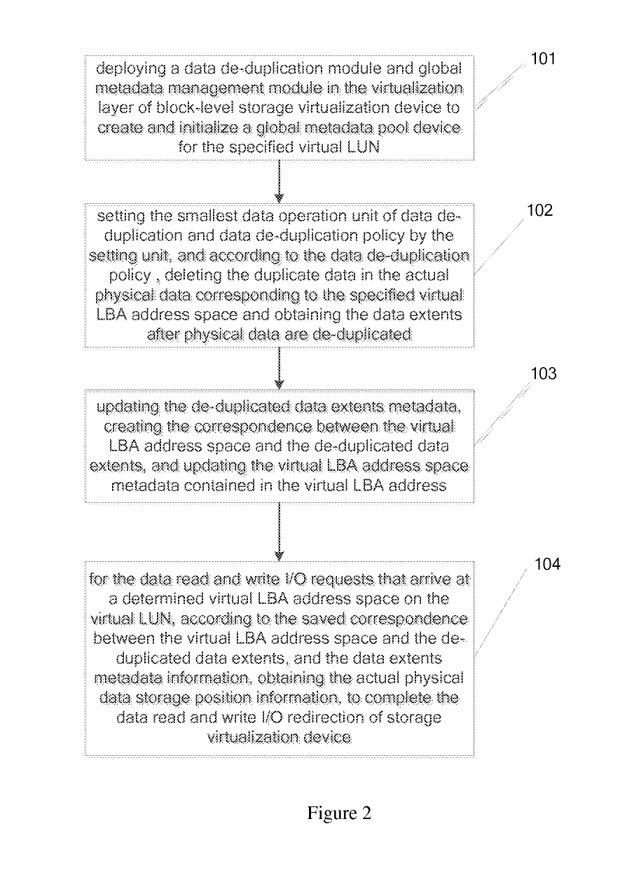

As shown in FIG. 1 and FIG. 2, based on the centralized metadata management system, the embodiments of this invention provide a method for achieving data de-duplication on block-level storage virtualization devices, including the following steps:

Step 101: deploying a data de-duplication module and global metadata management module in the virtualization layer of block-level storage virtualization device to create and initialize a global metadata pool device for the specified virtual LUN;

According to the actual system requirements, such as performance, functionality and data de-duplication ratio objective, to select a data de-duplication solution, and then according to the selected data de-duplication solution, to deploy the appropriate data de-duplication module; as mentioned above, the currently mainstream variable-length and post-processing data de-duplication solutions are chosen in this embodiment;

After a data de-duplication module is deployed, also to develop appropriate data de-duplication policy, including: to set the start-up time of data de-duplication engine (such as the evening when data read and write requests are not frequent), and to set the timing and cycle of data de-duplication space recycling; the definition of data de-duplication policy is often associated with the functional design of the data de-duplication module, and different data de-duplication solutions may lead to their corresponding data de-duplication policy to vary;

After deploying a data de-duplication module, to deploy a global metadata management module; then, to create a corresponding global metadata pool for the specified virtual LUN by the global metadata management module, and in the specific implementation, user can create an exclusive global metadata pool for each virtual LUN, or make it shareable by multiple virtual LUNs; as the implementation methods of the two are similar, the embodiment of this invention is only described by taking the approach to create an exclusive global metadata pool for each virtual LUN as the example;

After a global metadata pool is established, the global metadata management module needs to initialize it, and the specific steps are as follows: 1) to create a global metadata pool Dedup vLUN for a determined virtual LUN, and the global metadata management module through the storage virtualization module obtains the virtual LBA address space and the pointing information about from the virtual LBA address space to its already allocated actual LBA address space, and copies them one by one to the corresponding Dedup vLUN; In other words, at this time, for each determined virtual LBA address on the virtual LUN, the same virtual LBA address and same directing information about its corresponding actual physical data storage position can be found on Dedup vLUN; if the actual LBA address space corresponding to the virtual LUN is allocated dynamically (such as in the case of using thin provisioning), after its distribution, the information above will be copied to Dedup vLUN; 2) in the initial state, the actual physical data corresponding to the virtual LBA address in the global metadata pool are not de-duplicated, and the “not de-duplicated” state tag is used to mark these virtual LBA address metadata;

After deployment of a global metadata management module and global metadata pool, when a data access I/O reaches any determined virtual LBA address on the virtual LUN, the storage virtualization module needs to transmit the virtual LBA address to the global metadata management module, the global metadata management module returns the storage position information of the actual physical data to the storage virtualization module, and then the storage virtualization module completes the I/O redirection;

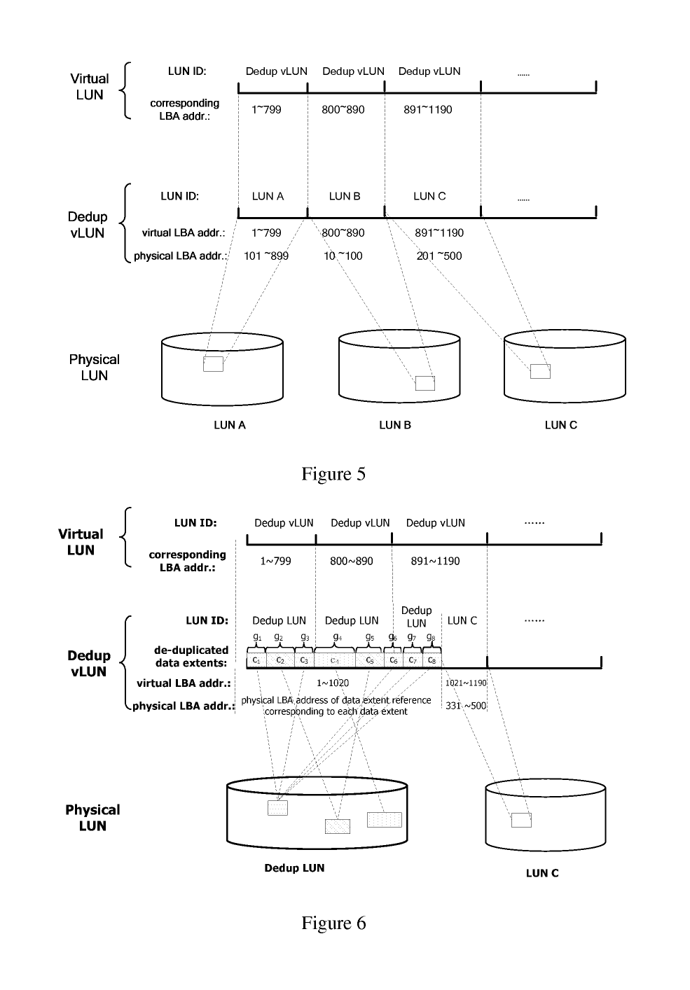

Compared with FIG. 4 and FIG. 5, it can reflect the changes before and after completion of Step 101: FIG. 4 shows the system architecture diagram not deployed with a data de-duplication module; it can be seen from FIG. 4 that storage virtualization is to redirect the virtual LBA address on the virtual LUN to the actual LBA address of the actual LUN (the LUN A, LUN B and LUN C in FIG. 4), to complete the I/O request sent over by the host; FIG. 5 shows the system diagram of the duplicate data that has not yet been deleted after a data de-duplication function module is deployed, where Dedup vLUN is a global metadata pool corresponding to the virtual LUN;

After initialization in Step 101 is completed, the virtual LBA address space of the virtual LUN (via the global metadata management module) will 1 to 1 correspond to the virtual LBA address space of Dedup vLUN, and Dedup vLUN also saves the storage position information of the actual physical data corresponding to these virtual LBA address space;

Step 102: setting the smallest data operation unit of data de-duplication and data de-duplication policy by the setting unit, and according to the data de-duplication policy, deleting the duplicate data in the actual physical data corresponding to the specified virtual LBA address space and obtaining the data extents after physical data are de-duplicated;

It should be noted that the virtual LBA address space in the embodiment of this invention is a virtual LBA address extent, containing a number of continuous or discontinuous virtual LBA addresses;

The setting unit unifies the smallest data operation unit of data de-duplication to the block level, so as to keep the same as the smallest data unit of storage media;

Depending on the data de-duplication policy set by the setting unit, to delete the duplicate data in the actual physical data corresponding to the specified virtual LBA address space, and to obtain the data extents after the physical data is de-duplicated, specifically including the following sub-steps: 1) after the obtention unit in the data de-duplication module interacts with the global metadata management module, to obtain the designated virtual LBA address space not de-duplicated and the corresponding actual physical data storage position information; 2) according to the actual physical data storage position information corresponding to the virtual LBA address space obtained by the obtention unit, the extraction unit in the data de-duplication module from the specified physical position of the actual physical data storage position information by block boundary extracts data of a specified length for data de-duplication, that is, the beginning position and ending position of the extracted data must be the block boundary, and the length of the extracted data is an integer multiple of block length; 3) according to the data de-duplication policy set by the setting unit, the segmentation unit in the data de-duplication module segments the extracted data of the specified length, using a block as the smallest unit, into the data extents of specified sizes (each segmented data extent is also composed of at least one complete block); 4) the data de-duplication unit in the data de-duplication module calculates the data fingerprints of the segmented data extents of the specified sizes and compares with the data fingerprints stored in the data fingerprint database for de-duplication, to obtain the data extents after the physical data corresponding to the specified virtual LBA address space is de-duplicated;

In Step 1), the global metadata management module needs to select a section of virtual LBA address not occupied by the data write and read process, and submit to the data de-duplication module for de-duplication according to the information saved in the specified virtual LBA address space metadata regarding whether the virtual LBA address has been de-duplicated, and the I/O requests status from the storage virtualization module;

Step 103: updating the de-duplicated data extents metadata, creating the correspondence between the virtual LBA address space and the de-duplicated data extents, and updating the virtual LBA address space metadata contained in the virtual LBA address;

After Step 102 is completed, according to the results of data de-duplication, the metadata management and updating unit in the data de-duplication module sends the metadata update content and request to the global metadata management module, and the global metadata management module integrates the data read and write condition and information in the data de-duplication process and updates each de-duplicated data extent metadata;

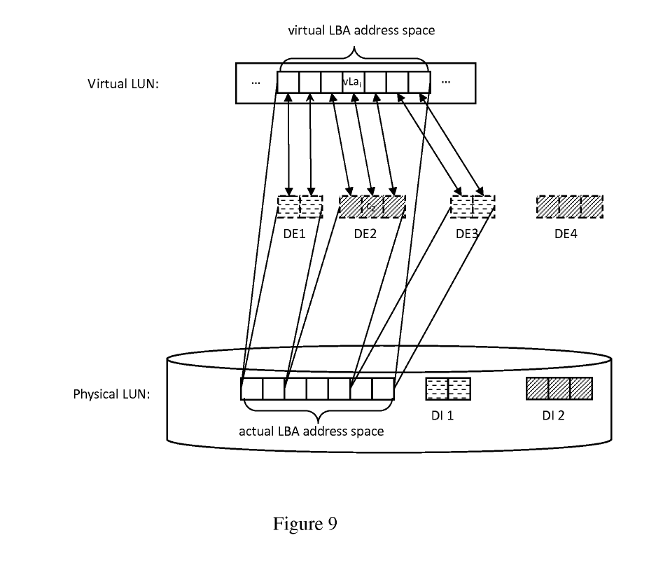

Further, according to the data de-duplication condition, the global metadata management module establishes the correspondence between the virtual LBA address space for data de-duplication and the data extents after its corresponding actual physical data is de-duplicated; as shown in FIG. 9, the virtual LBA address space of the data corresponds to the actual LBA address space of the physical LUN, and after the actual physical data saved in the actual LBA address space is de-duplicated, the data extents DE1, DE2 and DE3 are obtained, and they point to the data extent references DI1, DI2 and DI1 respectively; it can be seen from FIG. 9 that through the information about pointing and correspondence to the same actual LBA address space before the data de-duplication, each virtual LBA address in the virtual LBA address space can correspond to each block in data extents DE1, DE2 and DE3 (because the smallest operation unit of data de-duplication here is block, it is consistent with the smallest data management unit of storage media); in the figure the double arrow expresses this correspondence, that is, vLaᵢ is corresponding to c₂ in DE2;

After this correspondence is established, the specified virtual LBA address metadata will be updated with the identifier whether the actual physical data pointed by the virtual LBA address has been de-duplicated; If it has been de-duplicated, the metadata also includes its corresponding data extent and the offset from the head of the data extent; If not so (probably, the actual physical data corresponding to the virtual LBA address in the data de-duplication process is written, and then the process of the actual physical data de-duplication corresponding to the virtual LBA address is invalid, as detailed in Step 104), the metadata includes the directing information to the actual physical data storage position corresponding to the virtual LBA address;

After the metadata is updated, the released new physical space after data de-duplication needs to be periodically recycled, and the initiation and implementation of the physical space recycling may have different options in different system designs; for example, the storage virtualization module can be responsible for the management of the whole physical space, and the space recovery can also be initiated by it and completed by the data de-duplication module;

Compared FIG. 5 and FIG. 6, it can be seen the changes before and after Steps 102 and 103 are completed: FIG. 5 shows the system diagram of the duplicate data not to be deleted after a data de-duplication module is deployed, and Dedup vLUN is a global metadata pool corresponding to the virtual LUN; FIG. 6 shows the system diagram of some data de-duplicated after a data de-duplication module is deployed, and the data extents after data de-duplication are expressed as cᵢ(i=1, 2, . . . , 8, . . . n, n is a natural number); the length of each corresponding data extent (that is, the length of the actual LBA address of its corresponding data extent reference) is expressed as gᵢ(i=1, 2, . . . , 8, . . . n, n is a natural number), and the length of each data extent may be different due to the variable-length data de-duplication technology; for convenience of description, in this embodiment, a physical LUN device called “Dedup LUN” is created on the storage media, for storing the data extent reference corresponding to the data extent after data de-duplication; it needs to be noted that in this embodiment, the smallest data operation unit of data de-duplication has been set to the block level, so gᵢ is an integer multiple of the length of storage media block, and the data extent reference corresponding to each data extent is also composed of a number of complete blocks; at this time, in addition to saving a virtual LBA address space the same as the virtual LUN, Dedup vLUN also needs to save the metadata information corresponding to each virtual LBA address and the metadata information of the data contents after data de-duplicated;

Step 104: for the data read and write I/O requests that arrive at a determined virtual LBA address space on the virtual LUN, according to the saved correspondence between the virtual LBA address space and the de-duplicated data extents, and the data extents metadata information, obtaining the actual physical data storage position information, to complete the data read and write I/O redirection of storage virtualization device;

It should be noted that stemming from general considerations, the design of this step is mainly on the basis of the de-duplicated data I/O redirection for discussion, which is also the core problem this invention attempts to resolve; for the actual physical data not de-duplicated corresponding to the virtual LBA address accessed by the external data I/O, for example the post-processing de-duplication policy is used (such as the embodiment of this invention), it will be similar to the virtual storage device not deployed with data de-duplication module, and the I/O redirection is mainly based on the corresponding information pre-stored in the virtual LBA address metadata, between the virtual LBA address and the actual physical data storage position. The information in the embodiment of this invention on whether the actual physical data corresponding to the specified virtual LBA address is de-duplicated is stored in the virtual LBA address metadata for reference upon request;

When an external data access I/O request arrives at the specified virtual LBA address, the storage virtualization module sends this virtual LBA address to the global metadata management module, and the global metadata management module according to the metadata information corresponding to this virtual LBA address determines whether the actual physical data corresponding to this virtual LBA address has been de-duplicated; if not de-duplicated, the actual physical data storage position information corresponding to the virtual LBA address data is returned to the storage virtualization module; If de-duplicated, according to the virtual LBA address metadata information (the corresponding data extent and offset from the head of the data extent) and the corresponding data extent metadata information (including the actual storage position information of its corresponding data extent reference), the actual physical data storage position information is obtained by the following calculation (see FIG. 6) and is returned to the storage virtualization module:

Assuming that the corresponding physical data of the virtual LBA address vLa on the Dedup vLUN requested by the host data read and write I/O has been de-duplicated, it is corresponding to the position of the offset rLa from the head of the de-duplicated data extent c_{k:} because in the embodiment of this invention, the smallest data operation unit of data de-duplication is at block level, rLa is the LBA address length of vLa corresponding position in the cₖ relative to its head, then the actual data storage position pLa corresponding to the vLa required to be obtained, in fact, is an actual LBA address in the data extent reference corresponding to cₖ and can be calculated out by the formula (1):

pLa=pAddrₖₛ+rLa (1)

Where, pAddrₖₛ is the physical storage position starting LBA address of the data extent reference corresponding to cₖ data extent, and this information is known, stored in the data extent metadata after data de-duplication; at the same time, rLa is also a known information stored in the virtual LBA address metadata after data de-duplication, so through the above calculation, the actual data storage position information pLa corresponding to the determined virtual LBA address vLa can be obtained;

After obtaining the actual data storage position information returned by the global metadata management module, the storage virtualization module can complete the data read and write I/O redirection that reaches the virtual LUN, and the actual data read and write, specifically including the following situations:

1. Data read and write operations before data de-duplication;

After the global metadata management module creates and initializes Dedup vLUN, all virtual LBA address metadata already contains the storage position information of its corresponding actual physical data;

Before data de-duplication, all the data read and write I/O requests that reach the determined virtual LBA address of the virtual LUN, the global metadata management module returns directly the previously saved actual physical data storage position information corresponding to the virtual LBA address to the storage virtualization module, then the storage virtualization module completes the I/O redirection, and the whole process is basically the same as the storage virtualization devices with no data de-duplication, so such will not be detailed herein;

2. Data read and write operations after data de-duplication;

After data de-duplication, the actual physical data corresponding to at least part of the virtual LBA addresses on the virtual LUN or Dedup vLUN will be reconstructed into a few de-duplicated data extents, and this change makes the transformation mechanism of the virtual LBA address (to actual physical data storage position) quite different from the traditional storage virtualization, but is completely transparent for the host-level data I/O access;

1) Inline data read operation;

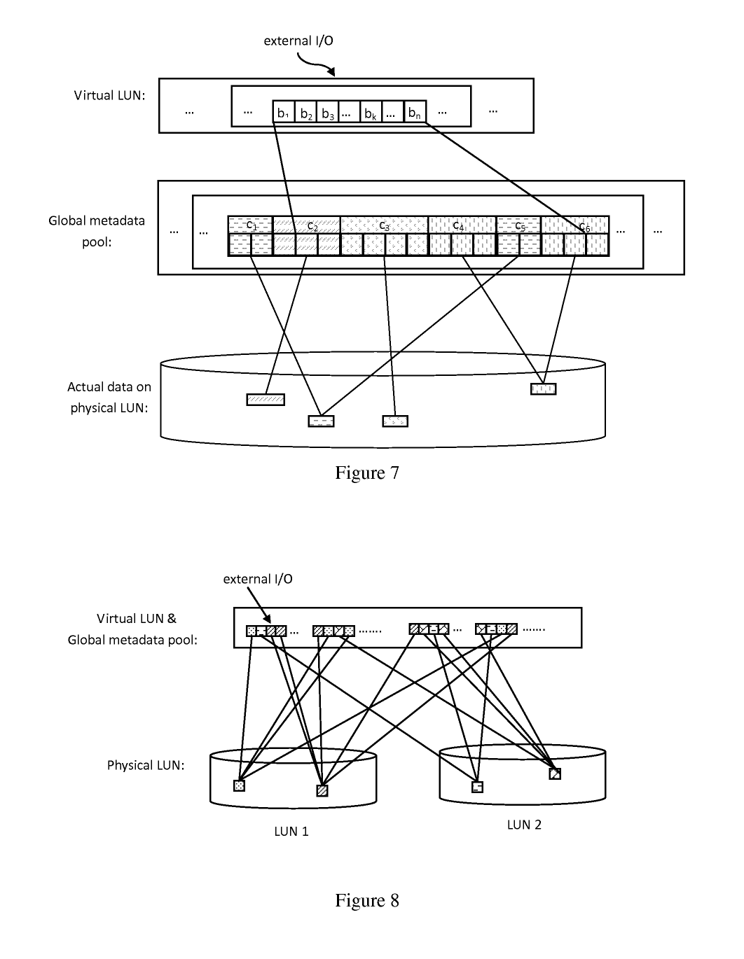

After data de-duplication, the process of data read operation is different from the data read operation before data de-duplication, as shown in FIG. 7: Suppose an external read I/O request is sent to a section of virtual LBA addresses on the virtual LUN (namely access the physical data mapped by b₁ to bₙ), the data read request of this section of virtual LBA address is sent by the storage virtualization module to the global metadata management module, and the global metadata management module finds that the physical data corresponding to the same section of the virtual LBA addresses on Dedup vLUN has been de-duplicated, and the corresponding data is the data between c₂ and c₆ in de-duplicated data extents (that is, the data from the second block of c₂ to the second block of c₆); after above transformation process, the LBA addresses of actual data (may be discontinuous) corresponding to the virtual LBA addresses are returned to the storage virtualization module, and then the storage virtualization module extracts data from the specified physical positions and returns to the external data read I/O requests;

2) Inline data write operation;

After data de-duplication, the process of data write operation is different from the data write operation before data de-duplication, as shown in FIG. 7: Suppose an external write I/O request is sent to a section of virtual LBA addresses (namely access the physical data mapped by b₁ to bₙ) on the virtual LUN, and then the storage virtualization module sends a write request of this virtual LBA address space to the global metadata management module, the global metadata management module finds that the physical data corresponding to the same virtual LBA address on Dedup vLUN has been de-duplicated, and the corresponding data is part of the data between c₂ and c₆ de-duplicated data extents (that is, the actual data corresponding to blocks from the second block of c₂ to the second block of c₆); thus,

(1) The global metadata management module allocates a new storage space on the back-end storage media for this write I/O via the storage virtualization module and returns the new storage space position information to the storage virtualization module, and the storage virtualization module then redirects the external write I/O to the new storage position and writes data;

(2) The global metadata management module allocates a new storage space on the back-end storage module media via the storage virtualization module, and the data de-duplication module copies the corresponding actual data of the data extent blocks (namely, the first block of c₂ and the third block of c₆) not affected by this write I/O in the data extent reference to the newly allocated storage position for saving;

(3) The global metadata management module updates the metadata information of the virtual LBA address space corresponding to the data extents c₂ c₆ in the global metadata pool: \textcircled{1} updating the metadata of virtual LBA address affected by this write I/O on the Dedup vLUN, and updating the directing information to its actual data storage position to the new data storage position allocated in Step (1); \textcircled{2} updating the metadata of virtual LBA address not affected by this write I/O on the Dedup vLUN, that is, the metadata of virtual LBA addresses corresponding to the first block of c₂ and the third block of c₆, and updating the directing information to their corresponding actual data storage position to the storage positions of their actual data in Step (2); \textcircled{3} marking the section of virtual LBA addresses (the length of the virtual LBA address may be greater than the length of the virtual LBA address affected by the write I/O) corresponding to the data extents c₂ to c₆ on Dedup vLUN as “not de-duplicated” state, and the data de-duplication module then de-duplicates it according to the preset data de-duplication policy;

(4) According to the preset policy, recycling periodically (if no other data extents point to the physical data) the physical space occupied by the data extent reference pointed by the blocks between the original c₂ and c₆ stored on Dedup LUN;

3. Data read and write operations in the data de-duplication process;

This is the coordination problem of conflict, and the global metadata management module is responsible for this; in the data de-duplication process, the virtual LBA address metadata in the global metadata pool has not been updated, so the metadata updating of the virtual LBA addresses involved in the data read and write I/O process will be locked by the global metadata management module;

In case of the data read I/O, after the I/O is complete, the virtual LBA address metadata involved in can be allowed to be updated, that is, original metadata information about its directing to the actual data position is updated to the information that the actual data corresponding to the virtual LBA address is already de-duplicated, and its corresponding data extent and relative offset from the data extent head;

In case of the data write I/O, appropriate measures need to be taken according to the progress of data de-duplication: if the data de-duplication process has not been completed, need to temporarily suspend the data de-duplication process (only for the data de-duplication task of the virtual LBA address associated with this write I/O), and after the normal data write operation is completed, restart (need to update the target data for data de-duplication); if data de-duplication has been completed, need to update the metadata of the corresponding virtual LBA address (the length of the virtual LBA address may be greater than the length of the virtual LBA address affected by the write I/O), then need to mark all the virtual LBA address extent metadata corresponding to the de-duplicated data extents associated with the write I/O request to “not de-duplicated”, and retain the directing information to its actual data storage position until deleting the duplicate data based on the data de-duplication policy later.

### Embodiment 2: Metadata Self-Management System

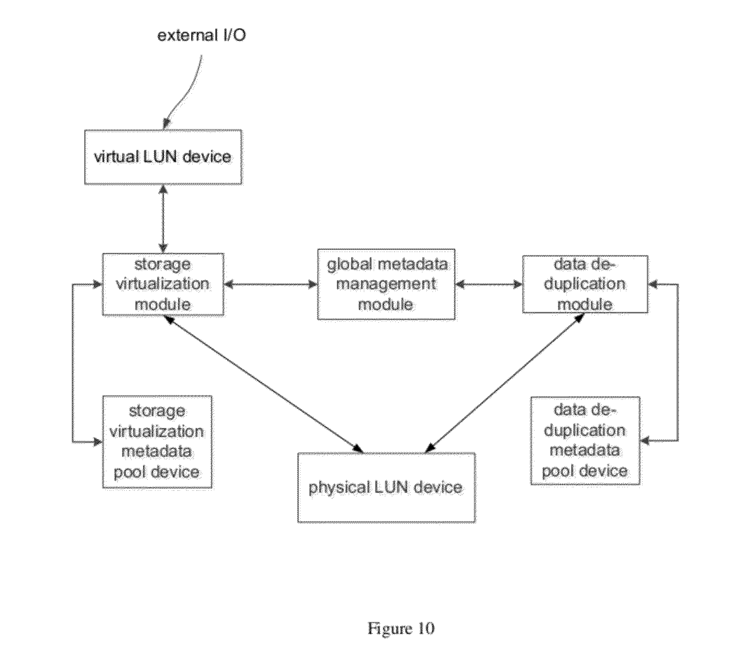

The differences between this system and the system in Embodiment 1 are: no global metadata pool device in the system similar to Embodiment 1 is used for metadata centralized storage and management throughout the system, replaced by the storage virtualization module and data de-duplication module responsible for managing and updating the virtual LBA address metadata and the de-duplicated data extent metadata respectively, as shown in FIG. 10. However, the contents of such two metadata are basically the same as Embodiment 1. Meanwhile, in order to ensure the consistency of the metadata, the role of the global metadata management module in this system is no longer the same as in Embodiment 1, that is, it is no longer primarily responsible for initializing the global metadata pool device, and for metadata centralized management and updating, but focuses on the metadata updating synchronization, coordination and interaction between the storage virtualization and the data de-duplication modules.

As shown in FIG. 10, the embodiment of this invention also provides a metadata self-management system for achieving data de-duplication on block-level storage virtualization devices, and the system comprises:

Virtual LUN device, used for providing the front-end host to mount and use;

Storage virtualization metadata pool device, used for storing the metadata information corresponding to the virtual LBA address space;

Data de-duplication metadata pool device, used for storing the metadata information of the data extents after data de-duplicated by the data de-duplication module;

Data de-duplication module, used for deleting the duplicate data in the actual physical data corresponding to the specified virtual LBA address space, to obtain the de-duplicated data extents, and updating the metadata information in the data de-duplication metadata pool device;

Global metadata management module, used for creating the correspondence between the virtual LBA address space and the de-duplicated data extents, and synchronizing and coordinating the metadata updating and interaction between the storage virtualization module and data de-duplication module;

Storage virtualization module, used for obtaining the storage position information of the actual physical data corresponding to the virtual LBA address space pointed by the external data read and write requests based on the correspondence established by the global metadata management module and the metadata information of the data extents after data de-duplicated by the data de-duplication module, to complete the I/O redirection, and updating the metadata information in the storage virtualization metadata pool device;

Physical LUN device, used for storing the actual physical data.

Further, the data de-duplication module comprises:

Setting unit, used for setting the data de-duplication policy and the smallest data operation unit of data de-duplication; the smallest data operation unit of data de-duplication is an integer multiple of block, bit or byte;

Obtention unit, used for obtaining the storage position information of the actual physical data corresponding to the specified virtual LBA address space;

Extraction unit, used for extracting the data of specified length for data de-duplication from the physical LUN device according to the storage position information of the actual physical data obtained by the obtention unit in accordance with the smallest data operation unit of data de-duplication set by the setting unit;

Segmentation unit, used for segmenting the data of the specified length extracted by the extraction unit according to the data de-duplication policy set by the setting unit into the data extents of specified sizes in accordance with the smallest data operation unit of data de-duplication set by the setting unit;

Data fingerprint database unit, used for storing data fingerprints; in the data de-duplication process, comparing the new data fingerprints generated and the fingerprint data in the data fingerprint database, in order to achieve data de-duplication;

Data de-duplication unit, used for calculating the data fingerprints of the data extents of specified sizes segmented by the segmentation unit, and comparing with the data fingerprints stored in the data fingerprint database unit and sending the comparison results;

Metadata management and updating unit, used for receiving the comparison results, and while the comparison results are the same data fingerprints, updating the de-duplicated data extents metadata through the coordination of the global metadata management module and sending to the data de-duplication metadata pool device.

The differences between this embodiment and the system in Embodiment 1 are also reflected in the following points:

1) Metadata saving and updating

The virtual LBA address metadata and the de-duplicated data extent metadata are no longer saved in the global metadata pool device, but they are respectively stored in the storage virtualization metadata pool device and the data de-duplication metadata pool device; the metadata is not updated by the global metadata management module, but by the storage virtualization module and data de-duplication module respectively; the metadata contents and the synchronization and coordination mechanisms of the global metadata management module in the metadata updating process are basically the same as in Embodiment 1.

2) Metadata obtaining

The specified virtual LBA address metadata is obtained from the storage virtualization metadata pool device after the storage virtualization module interacts with the global metadata management module; based on the virtual LBA address metadata information, to obtain the specified data extent metadata, the storage virtualization module sends the request to the global metadata management module, and after the global metadata management module interacts with the data de-duplication module, the data de-duplication module gets it from the data de-duplication metadata pool device and the global metadata management module finally sends it back to the storage virtualization module; the content of the metadata required to be obtained in the process is similar to that of Embodiment 1.

Based on the metadata self-management structure, the method provided by this embodiment to achieve data de-duplication on block-level storage virtualization devices is different from Embodiment 1 in the following:

Step 101: deploying a data de-duplication module and global metadata management module in the virtualization layer of block-level storage virtualization device;

Different from Embodiment 1, a global metadata pool device is not required to be created and initialized in the global metadata management module in this step; in addition to this step, the embodiment's other implementation details are consistent with Embodiment 1, so such will not be detailed herein.

The technical solution provided in the embodiment of this invention can delete the duplicate data across hosts and storage devices, to achieve a wider scope of data de-duplication; the technical solution provided in the embodiment of this invention does not take up the host system resources, thus ensuring that the business applications running on the host can run smoothly; the technical solution provided in the embodiment of this invention can centrally manage and protect the metadata of data de-duplication, thus simplifying the overall system design and implementation.

The specific implementation method above further details the purpose, technical solutions and beneficial effects of this invention, and it should be understood is that what is just described above is the specific implementation method of this invention, but is not used to limit this invention; any changes, equivalent replacements and improvements and other aspects made within the spirit and principle of this invention should be included in the protective range of this invention.

1. A method for achieving data de-duplication on a block-level storage virtualization device comprising:
deleting duplicate data in actual physical data corresponding to a specified virtual LBA address space to obtain data extents after the physical data is de-duplicated;
establishing correspondence between the virtual LBA address space and the data extents after the physical data is de-duplicated; and
obtaining storage position information of the actual physical data corresponding to the virtual LBA address space pointed by external data read and write request to complete the I/O redirection, according to the correspondence and metadata information of the data extents.

2. The method of claim 1 wherein before the step of deleting the duplicate data in the actual physical data corresponding to the specified virtual LBA address space, the method also comprises: setting a data de-duplication policy and a smallest operation unit of data de-duplication.

3. The method of claim 2 wherein the step of deleting the duplicate data in the actual physical data corresponding to the specified virtual LBA address space specifically comprises:
extracting data of a specified length for data de-duplication from the actual physical data corresponding to the virtual LBA address space, according to the smallest operation unit of data de-duplication;
dividing the data of specified length in accordance with the smallest operation unit of data de-duplication into the data extents of specified sizes according to the data de-duplication policy; and
calculating data fingerprints of the data extents of specified sizes and comparing with the data fingerprints stored in a data fingerprint database, and deleting the duplicate data in the actual physical data, according to the same comparison results of the data fingerprints.

4. The method of claim 3 wherein the step of obtaining the data extents after the physical data is de-duplicated also comprises: updating the metadata of the de-duplicated data extents.

5. The method of claim 4 wherein the smallest data operation unit of data de-duplication is an integer multiple of a block, a bit or byte.

6. The method of claim 1 wherein the structure of the block-level storage virtualization device is in-band or out-of-band architecture.

7. A system for achieving data de-duplication on a block-level storage virtualization device comprising:
a virtual LUN device for providing the front-end host to mount and use;
a data de-duplication module for deleting duplicate data in actual physical data corresponding to a specified virtual LBA address space to obtain de-duplicated data extents;
a global metadata management module for creating the correspondence between the virtual LBA address space and the de-duplicated data extents, managing and updating the metadata in the global metadata pool device, and obtaining storage position information of the actual physical data corresponding to the virtual LBA address space and sending the storage position information, according to the received virtual LBA address space, the correspondence and the metadata information of the de-duplicated data extents;
a global metadata pool device for storing the information of the correspondence established by the global metadata management module and the metadata information of the de-duplicated data extents obtained by the data de-duplication module;
a storage virtualization module for sending the virtual LBA address space requested by the external data read and write I/O to the global metadata management module, and receiving the storage position information of the actual physical data corresponding to the virtual LBA address space sent by the global metadata management module to complete the I/O redirection; and
a physical LUN device for storing the actual physical data.

8. The system of claim 7 wherein the data de-duplication module comprises:
a setting unit for setting the data de-duplication policy and the smallest operation unit of data de-duplication;
an obtention unit for obtaining the storage position information of the actual physical data corresponding to the specified virtual LBA address space;
an extraction unit for extracting the data of specified length for data de-duplication from the physical LUN device based on the storage position information of the actual physical data obtained by the obtention unit in accordance with the smallest data operation unit of data de-duplication set by the setting unit;
a segmentation unit for segmenting the data of specified length extracted by the extraction unit according to the data de-duplication policy set by the setting unit into the data extents of specified size in accordance with the smallest data operation unit of data de-duplication set by the setting unit;
a data fingerprint database unit for storing data fingerprints;
a data de-duplication unit for calculating the data fingerprints of the data extents of specified sizes segmented by the segmentation unit, comparing with the data fingerprints stored in the data fingerprint database unit, and sending the comparison results; and
a metadata management and updating unit for receiving the comparison results, and while the comparison results are the same, to send the metadata update content and request to the global metadata management module.

9. The system of claim 8 wherein the smallest data operation unit of data de-duplication is an integer multiple of block, bit or byte.

10. A system for achieving data de-duplication on a block-level storage virtualization device comprising:
a virtual LUN device for providing a front-end host to mount and use;
a storage virtualization metadata pool device for storing the metadata information corresponding to the virtual LBA address space;
a data de-duplication metadata pool device for storing the metadata information of the data extents after data de-duplicated by the data de-duplication module;
a data de-duplication module for deleting the duplicate data in the actual physical data corresponding to the specified virtual LBA address space, to obtain the de-duplicated data extents, and updating the metadata information in the data de-duplication metadata pool device;
a global metadata management module for creating the correspondence between the virtual LBA address space and the de-duplicated data extents, and synchronizing and coordinating the updating and interaction of the metadata between the storage virtualization module and data de-duplication module;
a storage virtualization module for obtaining the storage position information of the actual physical data corresponding to the virtual LBA address space pointed by the external data read and write requests according to the correspondence established by the global metadata management module and the metadata information of the data extents after data de-duplicated by the data de-duplication module to complete the I/O redirection, and updating the metadata information in the storage virtualization metadata pool device; and
a physical LUN device for storing the actual physical data.

11. The system of claim 10 wherein the data de-duplication module comprises:
a setting unit for setting the data de-duplication policy and the smallest data operation unit of data de-duplication;
an obtention unit for obtaining the storage position information of the actual physical data corresponding to the specified virtual LBA address space;
an extraction unit for extracting the data of specified length for data de-duplication from the physical LUN device based on the storage position information of the actual physical data obtained by the obtention unit, in accordance with the smallest data operation unit of data de-duplication set by the setting unit;
a segmentation unit for segmenting the data of specified length extracted by the extraction unit according to the data de-duplication policy set by the setting unit into the data extents of specified sizes in accordance with the smallest data operation unit of data de-duplication set by the setting unit;
a data fingerprint database unit for storing data fingerprints;
a data de-duplication unit for calculating the data fingerprints of the data extents of specified sizes segmented by the segmentation unit, comparing with the data fingerprints stored in the data fingerprint database unit, and sending the comparison results; and
a metadata management and updating unit for receiving the comparison results, and while the comparison results are the same, updating the metadata of the de-duplicated data extents through the co-ordination of the global metadata management module, and sending the updated metadata to the de-duplication metadata pool device.

12. The system of claim 11 wherein the smallest data operation unit of data de-duplication is an integer multiple of block, bit or byte.
